(19) United States
(12) Patent Application Publication
(10) Pub. No.: US 2016/0217499 A1
(43) Pub. Date: Jul. 28, 2016

(54) PROCESSING CONTENT REQUESTS

(71) Applicant: Google Inc., Mountain View, CA (US)

(72) Inventors: Satya Patel, Foster City, CA (US); Gokul Rajaram, Los Altos, CA (US)

(21) Appl. No.: 15/089,111

(22) Filed: Apr. 1, 2016

Related U.S. Application Data
(63) Continuation of application No. 11/692,052, filed on Mar. 27, 2007.

(51) Int. Cl. G06Q 30/02

(52) U.S. Cl. CPC G06Q 30/0275

(57) ABSTRACT

Systems and methods for allocating content include a system comprising a data structure storing different types of item requests for items, each item request having a different corresponding time at which the items are allocated to that request type. Servers allocate a same given item to various different requestors at different times. For a first portion of allocations of the same given item, servers determine that the plurality of different types of item requests includes a reservation request. For a second portion of the allocations, the servers determine that the same given item will not be allocated to a reservation request. For a third portion of the allocations of the same given item, the servers determine that the same given item will not be allocated to a reservation request or an advance allocation request. The servers evaluate the reservation requests, advance allocation requests, and other requests during in an auction.

### CROSS-REFERENCE TO RELATED APPLICATION

This is a continuation of U.S. application Ser. No. 11/692,052, filed on Mar. 27, 2007, the disclosure of which is considered part of and is incorporated by reference in the disclosure of this application.

### TECHNICAL FIELD

The subject matter of this document relates generally to advertising.

### BACKGROUND

An entity wishing to advertise using a medium may purchase from advertisement (“ad”) slots associated with the medium. Available ad slots form an inventory. The entity can access available inventory through a tool or advertisement management system, such as the AdSense or AdWords advertisement systems available from Google, Inc. of Mountain View Calif. Purchases of ad slots may be performed ad hoc or may be part of a larger advertisement campaign.

Ad slots may be defined by any number of parameters, such as positioning, frequency, size, media type, location, distribution, and the like. Inventories of ad slots are available from any number of sources, including on-line content sources, such as web-site owners, on-line publishers, and the like.

On-line content sources may provide ad slots for purchase by using web-based tools, web-sites, advertisement systems and tools, such as those referenced above, and various other means and methods for making such slot information available so as to facilitate purchase thereof such as through a network.

Currently, one approach to buying and selling on-line ad slots involves an auction context where multiple bids are solicited for a given advertisement slot. At the time for the auction to close, a highest bidder can be allocated the slot. Thus, for example, advertisers may bid certain amounts for their ads to appear in conjunction with the results of a web search when certain keywords are used in such searches (i.e., for their ad to be placed in a slot that is part of a page that is returned in response to a search).

One of the drawbacks to this auction approach for advertisers is a certain amount of budget uncertainty caused by uncertainty as to whether the advertiser's bid will be accepted for the advertisement slot, or at what price. Similarly, for a publisher, a conventional auction approach may not always match inventory to opportunities for purchase of such inventory.

Another conventional approach to buying and selling on-line ad slots allows ad slots to be offered for direct sale and for subsequent use by the purchasing advertiser (e.g., a reservation context). In this approach, the purchaser reserves ad slots by paying a reserve price to guarantee that the slot will be available to the purchaser. Though more certain, the guarantee provided in a reservation context typically requires a premium payment by the purchasing entity.

### SUMMARY

In one implementation, a system and related method receives input from multiple requestors for advance purchase of an advertisement slot. A determination is made as to which of the requestors shall be allotted the advertisement slot. Such determination is made in advance of presenting content associated with the advertisement slot.

In another implementation, the inputs received include data corresponding to monetary amounts, and the determination of a high bidder for the advertisement slot is based on the monetary amounts received.

In reference to still another implementation, a computer system includes an inventory of advertisement slots stored in a user-accessible data structure. At least one of the advertisement slots is available for purchase in advance (e.g., in advance of the determination of what content is to be placed in such advertisement slot). The system can be operated to receive data corresponding to the advertisement slot available for purchase in advance and to update the inventory of advertisement slots to reflect one or more transactions related to an advance purchase of an advertisement slot. The system is also able to receive requests for advance purchase of an advertisement slot and, in the case of multiple requests, the system is able to identify a high bidder of the advertisement slot.

In a still further implementation, a device is operable to receive multiple inputs from multiple potential advertisers for a given advertisement slot. The inputs may correspond to different ways of requesting the same advertisement slot. Those different ways may include a request for advance purchase or a reservation.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic of example advertisement system.

FIG. 2 is a schematic of another example advertisement system.

FIGS. 3-5 are flowcharts of various, possible methods for requesting an advertisement slot.

Like reference numbers in the various drawings indicate like elements.

### DETAILED DESCRIPTION

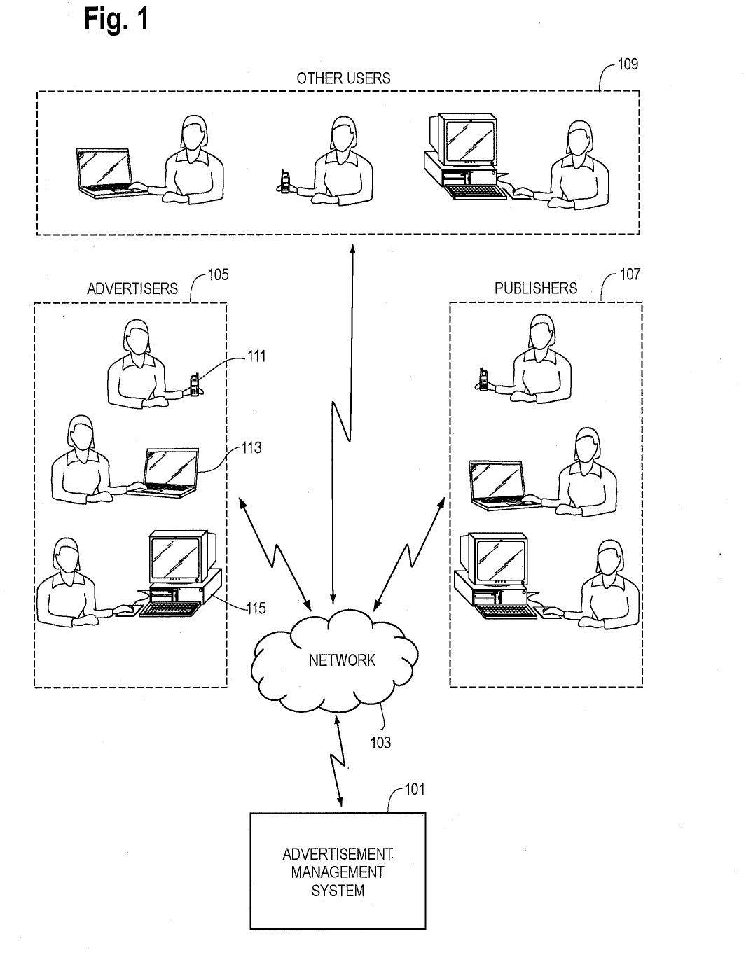

FIG. 1 is a schematic of one implementation of an example advertisement management system 101 as described herein. Advertisement management system 101 may be configured to include some or all of the features discussed below. Advertisement management system 101 is accessible by way of a network 103, such as the Internet. Advertisers 105, publishers 107, and other users 109 may access advertisement management system 101 using network 103 by way of any number of electronic devices, including, for example, cell phones and PDAs 111, laptops and other portable computerized devices 113, or personal computers, workstations, servers, and other types of computers 115 or electronic devices.

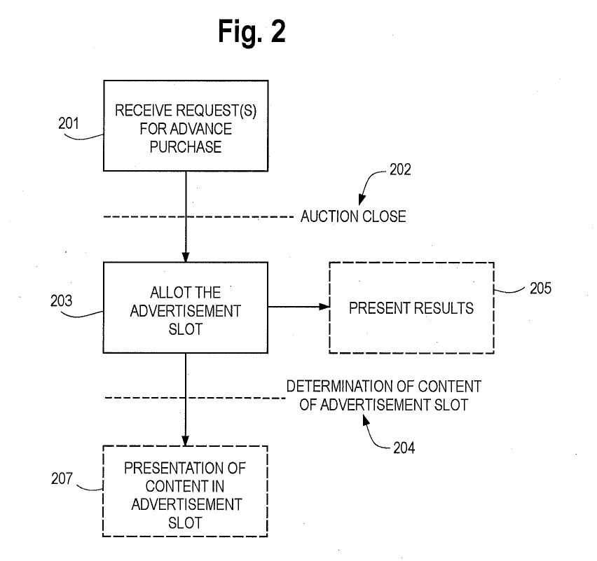

System 101 is able to receive and process one or more requests to purchase a given ad slot and to allot the ad slot to one of the requestors in advance of presenting the contents of the advertisement slot. For example, referring to FIG. 2, one or more requests for advance purchase of an advertisement slot are received (block 201). A deadline for receiving the requests for the advertisement slot is established or determined, such as a date for an auction to close (reference 202). The requests may include consideration (e.g., monetary amounts) and thus can be considered bids for purchase of an ad slot to be allotted to one of the bidders at a future point in time.

After the deadline or auction close (reference 202), a determination of which of the advertisers shall be allotted the advertisement slot is made (block 203). The determination of which of the requestors shall be allotted the ad slot may be suitably recorded, such as in a data structure. Such determination may be made in advance of, that is, at a point in time before, presenting the contents (e.g., the advertisement) of the advertisement slot (reference 204). In one possible scenario, a deadline or auction close is set twenty-four hours before the start date associated with the advertisement slot, that is, the time it is scheduled to be filled with content and presented. In one implementation, the advertisement slot is allotted to the bid having the highest value, that is, the requester who is the high bidder.

The determination (i.e., of the winning bidder) may also be presented to one or more users, including other advertisers who submitted requests (e.g., bids) for the advertisement slot (block 205). It will be appreciated that the timing and time periods between the allotment of the advertisement slot to one of the requestors, the presentation of content associated with the advertisement slot, and the presentation of results to users may be varied depending on any number of factors, and that twenty-four hours is merely one suitable point in time in advance of the start date (e.g. presentation) of the advertisement in the associated advertisement slot. In certain implementations, the advertisement slot is allotted, and the results of such allotment are available, sufficiently in advance of presentation of content so that at least some of the requestors may learn of the determination before the scheduled start of the ad slot. In this way, advertisers who may have requested advance purchase of the advertisement slot (block 201), but who were not successful (i.e., the advertiser was not allotted the advertisement slot), may be able to make requests or arrangements for the purchase of other advertisement slots, including potentially those scheduled to be presented in the same or similar time frame. This may allow certain advertisers to more optimally or more flexibly allocate their advertisement budget or otherwise adapt an associated advertisement campaign to the dynamics of a competitive bidding situation for ad slots.

Once a determination is made as to which requester shall be allocated the ad slot, a determination of the contents (e.g., the advertisement) is made, the contents generally being associated with the requestor, and, at the scheduled time, the advertisement is presented (block 207).

The presentation of the advertisement in the advertisement slot (block 207) may assume a variety of different forms. In one implementation, the advertisement slot is associated with flight dates, that is, start and end dates, and presentation may occur multiple times during such flight dates.

The scheduled times to determine the contents of the ad slot (reference 204) and present the advertisement in the advertisement slot (block 207) may also be varied to suit any number of applications. Likewise, the timing for presenting which of the requestors was allotted the advertisement slot (block 205) can be varied to suit the particular application and can include the possibility of presenting the decision on advertisement slot allotment in response to user request.

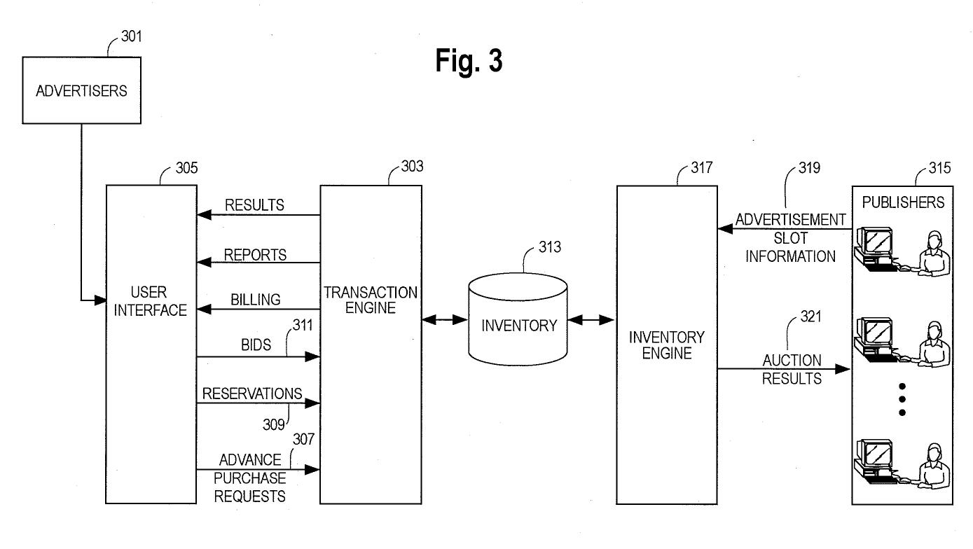

Referring now to FIG. 3, one implementation of system 101 includes three ways for advertisers to request an advertisement slot, as explained below. More specifically, advertisers 301 may access a transaction engine 303 through any suitable user interface 305. Transaction engine 303 is operable to receive and process multiple (e.g., three) different types of requests for advertisement slots: advance purchase, reservation, and conventional auction. Advance purchase transactions were discussed above with respect to FIG. 2 (reference 307). As discussed above, advance purchase transactions include two fundamental characteristics: an auction context decides which advertiser is awarded a given slot, and the auction close is prior to (and not insubstantially so), and not coincident with, the time for presentation of the content in the advertisement slot. A second method for requesting/purchasing from ad inventory is to make (e.g., purchase) a reservation for one or more ad slots, which results in its allotment in conjunction with such reservation. As discussed above, unlike an advance purchase request, the reservation, once approved, is allotted to the advertiser requesting such reservation without competition with others.

A third way of requesting an advertisement slot is by auction, in which multiple bids are received, and allotment of the advertisement slot is determined in conjunction or coincident with presenting the advertisement in such slot (reference 311). This third bid/auction option may include, for example, submitting competitive bids for placement of advertisements on search results pages, which placements may depend on the amounts bid and in the keywords used in the associated queries which led to such search results.

Though reference is made that this third option is coincident with the presentation of the content in the advertisement, it should be appreciated that for this third bid/auction option, there may be considerable variation between the time when the bids are received, the time for allotting the advertisement slot(s) among the multiple bids, and presenting one or more advertisements in such slot(s). In some implementations, the amount of variation will be non-insubstantial. Even with such a lag time, in this implementation, the presentation of the advertisement would still be considered to have occurred in conjunction with the allotment of the advertisement slot, especially if there is insufficient or effectively insufficient time for potential advertisers to react to the allotment of the advertisement slot to another bidder.

Transaction engine 303 accesses inventory 313 of advertisement slots, which is stored in any suitable, accessible data structure. Transaction engine 303 is also operable to receive data corresponding to consideration (e.g., monetary amounts associated with a bid or reserve price) associated with any of the three types of requests for advertisement slots. In the case of the request for advance purchase, transaction engine 303 includes suitable programming to identify a high bidder for a corresponding advertisement slot by determining which of the consideration amounts (e.g., monetary amounts) received has the highest value. As mentioned previously, for advance purchase requests, the identification of the high bidder may occur at a separate point in time before presenting the content in the advertisement slot.

Transaction engine 303 may also include features for billing advertisers, generating reports, such as those of use or interest to advertisers and other users, and may also present results of requests for advertisement slots to one or more users, either automatically or in response to a request. Among the results which can be communicated by transaction engine 303 is the acceptance of the high bidder's request for advance purchase of a corresponding advertisement slot(s), such as through user interface 305. Transaction engine 303 may also report to one or more advertisers 301 that their requests for advance purchases were not accepted and, in conjunction with such notification or entirely separate therefrom, transaction engine 303 may present to such advertisers information related to other advertisement slots available to a requestor for a similar opportunity (e.g., similar time slot, reach ad, etc.) or other ways for purchasing similar advertisement slots.

Transaction engine 303 may include suitable programming to update the inventory 313 to reflect one or more transactions related to the requests for advertisement slots contained therein. Updates can include removal of inventory at the close of auction bidding (by way of conventional auction or advance purchase) or after a reservation has been submitted.

Inventory 313 may be structured, subdivided, or otherwise organized in any number of suitable ways, and may include any and all data necessary and appropriate to effect operation of the features of system 101. In this implementation, ad slots are provided to inventory 313 by one or more publishers 315 through an inventory engine 317. More specifically, a publisher 315 may designate ad slots as being available for request by any or all of the three ways discussed previously, that is, advance purchase request, reservation, and/or bid. Inventory engine 317 receives data corresponding to the ad slots available, including various parameters, such as flight dates, size, frequency, restrictions, preferences, costs, commission, and any other parameters suitable for offering the ad slots for purchase (reference 319).

Inventory engine 317 may likewise include any other additional features for processing or handling ad slots, including features useful to publishers 315. One useful feature may include, for advance purchase requests, communicating the results of an advance purchase auction to one or more appropriate publishers (reference 321), and enabling such publisher to accept or approve allotment of an ad slot to the corresponding advertiser, such as the high bidder.

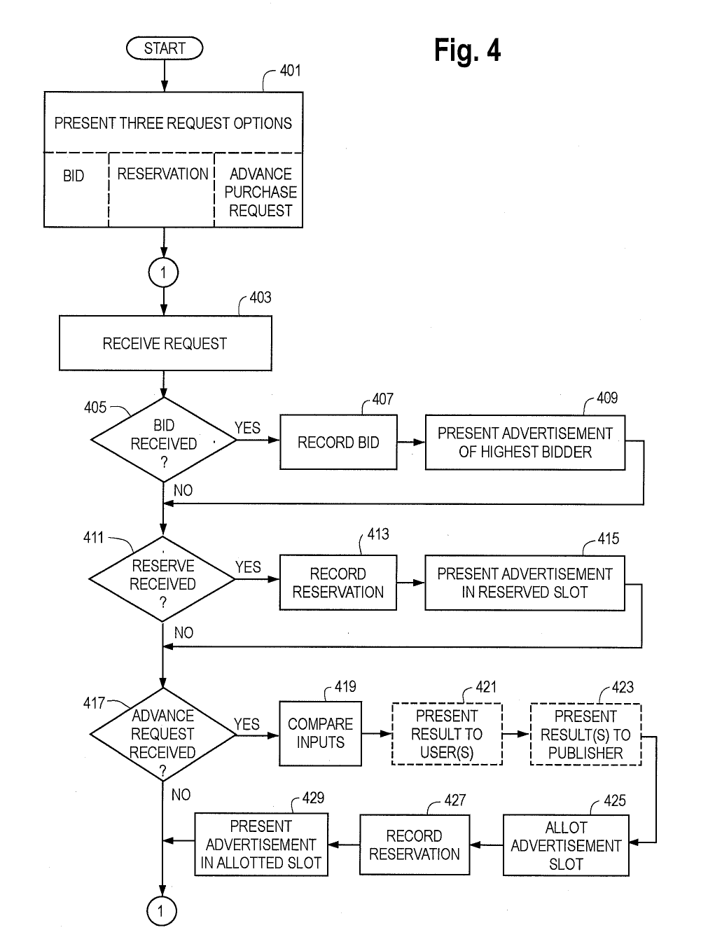

Referring now to FIG. 4, one example method for receiving and processing requests for advertisement slots includes presenting multiple request options for selection by a requestor (e.g., an advertiser) (block 401). In the implementation shown, three different options are presented including an advance purchase option, a reservation option and a conventional auction option.

In response to receiving input(s) from one or more requestors (block 403), such inputs are suitably processed to determine what type of request has been made. If the first type of request, that is, a bid, has been received (block 405), the bid is suitably recorded in memory or other data structure (block 407) and at an appropriate time, the advertisement of the highest bidder is presented in the advertisement slot (i.e., respond to a conventional auction request) (block 409).

If a request for a reservation is received (block 411), the reservation is recorded in memory or other suitable data structure (block 413), and, unlike the bid option discussed immediately above, there is more certainty within the reservation option that the requestor's advertisement will be presented in accordance with the costs, terms, and conditions of the reservation made (block 415).

If an advance purchase request is received (block 417), the corresponding input, which may include a consideration amount (e.g., a monetary amount in the form of a bid), is compared to other corresponding inputs, if any, from other requestors (block 419). In some implementations, the comparison is made at the time the request is submitted (e.g., allowing time for notifying the bidding party that their bid is too low and should be modified (i.e., would not win based on other received bids)). Alternatively, the comparison can occur at the time of closing (or soon thereafter i.e., a sealed bid auction format) of the auction. The deadline (e.g., time of closing of the auction) may be any point in time, including a point in time sufficiently in advance of the launch date (e.g., flight) of the advertisement slot to be discernible and actionable to the requestors. In this implementation, the comparison of inputs (419) is performed after the deadline for receiving requests for the corresponding advertisement slot, in order to determine a high bidder, that is, a winning bid. Other variations are possible, including an open bid approach, in which a comparison of inputs in block 419 is done before the auction close date and time, and such approach could induce receiving subsequent, higher bids from the same requestor as the comparison of inputs is communicated to such requestors.

The results of comparing inputs, such as determining the high bidder, are optionally presented to users, including the requestors (block 421), and also may be presented to the source of the advertisement slot (e.g., a publisher) (block 423). Presenting the results of the auction based reservation to users, especially requestors, provides information which may be useful to users in a number of ways, as discussed above. By informing the high bidder that the bidder has been allotted the advertisement slot requested, the high bidder is given some certainty as to the advertisement spending and strategy and can turn attention to other aspects of the advertisement campaign if desired.

As for presenting the results to the publisher (block 423), this information may be useful in a number of ways. For example, if a publisher receives results sufficiently in advance of advertisement slot flight dates, the publisher has the flexibility to factor in any number of criteria before deciding whether to allot the advertisement slot to the corresponding high bidder. More specifically, a publisher may wish to filter or exclude certain advertisers from the publisher's content or from certain advertisement slots on its website, such preferences being motivated by any number of factors. The publisher may wish to balance advertisements appearing over the website or over time in a given location on the website. Furthermore, the publisher may wish to include other monetary and non-monetary factors in determining which request for a given advertisement slot has the highest value.

Once the advertisement slot has been allotted (block 425), such allotment (e.g., reservation) is recorded in suitable memory or other data structure (block 427), and, at the appropriate time(s), the appropriate contents (e.g., advertisement) are presented in the allotted slot (block 429).

The method described above with reference to FIG. 4 may be practiced by multiple users for multiple advertisement slots, in multiple inventories, at multiple points in time and in any number of variations.

A potential advertiser may perform some or all of the above-described steps in conjunction with an advertisement campaign. As one particular example, an on-line advertiser may be interested in delivering its ads to job seekers on websites associated with newspapers. Such advertiser would follow suitable prompts on user interface 305 (FIG. 3) to set up an on-line advertisement campaign in which advertisements will appear on certain newspaper-related web-sites which are part of a network of content sources accessible through system 101. The advertiser may use certain web-based tools to identify several newspaper web-sites on which it wishes to place on-line advertisements and corresponding advertisement slots. As part of this process, the advertiser is presented information about advertisement slots on the desired web-sites, and such information may include the terms and conditions under which slots can be requested. Some or all of the advertisement slots may be available for bid, reservation, or advance purchase, as discussed above. Depending on the desired ad campaign, the relative importance of certain newspapers web-sites, and any number of other factors, the advertiser decides what mix of requests for advertisement slots to make among the various possibilities.

So, one approach chosen by the advertiser could be to spend advertising dollars making reservations on one or more newspaper web-sites which are considered more critical to the advertisement campaign.

For other web-sites, the advertiser may make certain advance purchase requests, which requests may or may not result in allotment of the requested advertisement slot. Still further, the advertiser may wish to limit its expenses on certain newspaper web-sites to bids on unreserved inventory, in which particular placements may be subject to still greater uncertainty then in the case advance purchase request.

The reservations and other options chosen by the advertiser may be accomplished with an eye toward staying within a daily advertisement campaign budget, and advertising system 101 may be suitably programmed to account for such budget, either through various user-selectable tools, or automatically in other operations.

The advertiser may also factor in any number of other parameters related to the advertisement slots available, such as flight dates, specific volume of guaranteed impressions, information about the publisher, costs, commission, and other monetary factors.

Through suitable tools, the advertiser may set various pricing parameters associated with the request for advertisement slots, including a single max CPM (cost for thousand impressions) to bid for unreserved inventory that the advertiser is interested in targeting. The advertiser may also provide a single max CPM bid for the advance purchase requests that it is interested in purchasing.

For advance purchase requests, the advertiser may be presented with information that the auction close ends a set number of hours prior to the start date of the corresponding advertisement slot. There may also be information about the number of clicks likely or guaranteed to be associated with the advertisement slot.

Transaction engine 303 (FIG. 3), may be suitably programmed to update advertising budgets of advertisers to reflect their being allotted an advertisement slot via the advance purchase request, being granted an immediate reservation, or receiving ad placements in response to a conventional auction bid. Continuing with this example, if the advertiser is not allotted the advertisement slots that it anticipated in its advance purchase request, the advertiser may adapt the advertisement campaign by paying a different price, which may be more elevated, for a reservation of another advertisement slot from the same content provider, in this case a newspaper web-site. In such case, the advertiser, through user interface 305, may be presented with alternative advertisement slots and the associated terms and conditions for requesting them.

The advertiser may have the ability to be informed of the results of its request for advance purchase after the auction close. The advertiser may have availed itself of this option by choosing, for example, a notification preference available through a suitable user interface. Alternately, if the advertiser has not elected to receive auction results independently, such as by email, it may nonetheless be able to determine such results by seeing how its ad campaign has progressed. Transaction engine 303 may be suitably programmed to provide campaign summary information, from which it would be apparent which, if any, of the auctions the advertiser has won and thereby been allotted corresponding advertisement slots. Similar reports which may be made available to the advertiser may be accessed through a suitable user interface, such as to or through a report center, including campaign performance reports, ad group performance reports, and site/key word performance reports, to name a few examples.

It will be appreciated that the three different options of bid, reservation, or advance purchase should not be tied to any particular hierarchy of importance vis-à-vis their use with certain sources of advertisement slots. That is, any number of factors may come into play for a requestor to decide which request option to use among the multiple options available. Further, though three different options are presented more, different or fewer options can be presented.

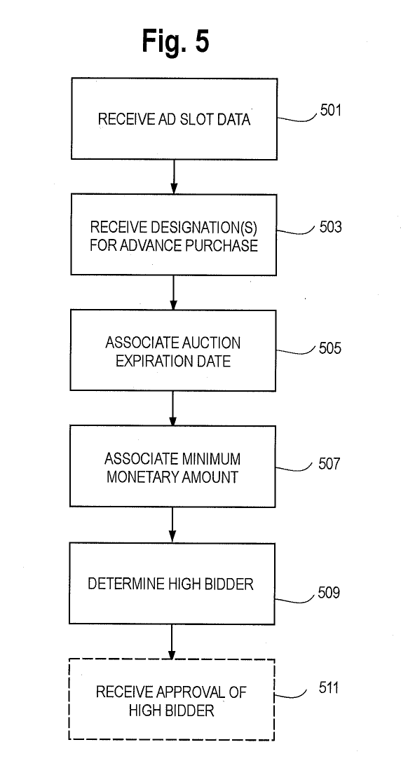

Publishers provide advertisement slot inventory for use by system 101 in any number of suitable ways. For example, referring to the exemplary method shown in FIG. 5, a content provider (e.g., web-site publisher) determines its inventory of ad slots which it wishes to make available, such as through a corresponding network. Information about the ad slot is received for use in making such ad slot available for request by others (block 501). Data received can include information for monetization of the ad slot inventory, including costs, commission, and other parameters relating to the advertisement slot.

The provider of advertisement slots may designate some or all of those slots as being available for advance purchase by multiple requestors, as discussed previously (block 503). For those advertisement slots available for advance purchase, an auction close deadline for receiving advance purchase request is associated with the advertisement slots (block 505). Minimum monetary amounts, such as minimum cost per thousand impressions (CPMs) may be associated with advertisement slots available for advance purchase (block 507). If multiple requests are received for a given advertisement slot available for advance purchase, a determination is made of which requestor should be allotted the advertisement slot. When such determination is based on which request has the highest value, a high bidder may be determined (block 509). Optionally thereafter, approval of the high bidder determined previously may be received by the system for further processing (block 511).

The foregoing methods of offering advertisement slots for sale, requesting advertisement slots, and performing related transactions may be accomplished through suitable software, hardware, or a combination of the two. In one implementation, one or more web-based software applications running on suitably programmed servers are accessible via a network by users using suitable interfaces of electronic devices. System 101 may be implemented in this fashion, including engines 303, 317. It is understood that the features and functions of system 101 may be located on and performed by any number of suitably programmed computers or other electronic device, and that the grouping of certain features and functions into engines 303, 317 in this implementation is just one of the many possible architectures of system 101. Other variations are possible.

A number of embodiments of the invention have been described. Nevertheless, it will be understood that various modifications may be made without departing from the spirit and scope of the invention. Though reference is made above to a conventional publisher-advertiser transaction, other transaction types are possible. For example, publisher's can make inventory (e.g., available advertisement slots) available to advertisers or other entities (e.g., other publishers, marketers, 3^{rd} party distributors, etc). For example, a publisher (Publisher A) might specify a commission or absolute dollar amount that he is willing to pay to a second entity (e.g., Publisher B) should the second entity (Publisher B) sell Publisher A's inventory in any of the ways designated by Publisher A. Accordingly, other embodiments are within the scope of the following claims.

What is claimed is:

1. A system comprising:
a data structure storing a plurality of different types of item requests for items, wherein the different types of item requests each have a different corresponding time at which the items are allocated to that request type; and
one or more servers that are coupled to the data structure and allocate a same given item to various different requestors at different times based on the plurality of different types of item requests that have been submitted for the given item, wherein:
for a first portion of the allocations of the same given item, the one or more servers determine, prior to an allocation time for that allocation of the same given item, that the plurality of different types of item requests includes a reservation request that allocates the same given item to a requestor corresponding to the reservation request prior to the allocation time for that allocation of the same given item;
for a second portion of the allocations of the same given item, the one or more servers determine, prior to an allocation time for that allocation of the same given item, that the same given item will not be allocated to a reservation request, but that an acceptable advance allocation request is included in the plurality of different types of item requests, allocate the same given item to a requestor corresponding to the advance allocation request prior to an allocation time for that allocation of the same given item, and transmit a notification to other advance allocation requestors that the same given item has already been allocated; and
for a third portion of the allocations of the same given item, the one or more servers determine, prior to an allocation time for that allocation of the same given item, that the same given item will not be allocated to a reservation request or an advance allocation request, and allocate the same given item at an allocation time corresponding to that allocation of the same given item, wherein the one or more servers evaluate the reservation requests upon receipt of the reservation requests, evaluate the advance allocation requests together at a first specified time prior to an auction of the same given item, and evaluate other requests during in an auction.

2. The system of claim 1, wherein the requests include data specifying various numeric values, wherein the one or more servers further determine a highest value based on the data in the request.

3. The system of claim 1, the one or more servers further record a determination of a requestor that submitted the highest value in the data structure.

4. The system of claim 1, wherein the one or more servers further present, in response to a request, information provided by the requestor that was allotted the same given item.

5. The system of claim 1, wherein the one or more servers further update information associated with allocation of the same given item after the determination.

6. The system of claim 1, wherein the one or more servers further update multiple information associated with various requestors after the determination, including updating information associated with a requestor that did not submit the highest value to indicate resources available to apply to other additional requests because of not submitting the highest value.

7. A method comprising:
accessing a data structure that stores a plurality of different types of item requests for items, wherein the different types of item requests each have a different corresponding time at which the items are allocated to that request type; and
allocating, by one or more servers, a same given item to various different requestors at different times based on the plurality of different types of item requests that have been submitted for the given item, including:
for a first portion of the allocations of the same given item, determining, by the one or more servers and prior to an allocation time for that allocation of the same given item, that the plurality of different types of item requests includes a reservation request that allocates the same given item to a requestor corresponding to the reservation request prior to the allocation time for that allocation of the same given item;
for a second portion of the allocations of the same given item, determining, by the one or more servers and prior to an allocation n time for that allocation of the same given item, that the same given item will not be allocated to a reservation request, but that an acceptable advance allocation request is included in the plurality of different types of item requests, allocating, by the one or more servers, the same given item to a requestor corresponding to the advance allocation request prior to an allocation time for that allocation of the same given item, and transmitting, by the one or more servers, a notification to other advance allocation requestors that the same given item has already been allocated; and
for a third portion of the allocations of the same given item, determining, by the one or more servers and prior to an allocation time for that allocation of the same given item, that the same given item will not be allocated to a reservation request or an advance allocation request, and allocating, by the one or more servers, the same given item at an allocation time corresponding to that allocation of the same given item, wherein the one or more servers evaluate the reservation requests upon receipt of the reservation requests, evaluate the advance allocation requests together at a first specified time prior to an allocation of the same given item, and evaluate other requests during an auction.

8. The method of claim 7, wherein the requests include data corresponding to monetary amounts, the method further determining a high bidder for the item request based on the monetary amounts.

9. The method of claim 7, further comprising recording the determination of the requestor in the data structure.

10. The method of claim 7, further comprising presenting, in response to a user request, information corresponding to which of the requestors was allotted the given item.

11. The method of claim 7, further comprising updating a campaign associated with the given item after the determination.

12. The method of claim 7, further comprising updating multiple campaigns after the determination, including updating at least one campaign associated with the losing requestor to indicate available budget to be spent on other additional requests based on losing the auction.

13. A non-transitory computer storage medium encoded with a computer program, the program comprising instructions that when executed by a distributed computing system cause the distributed computing system to perform operations comprising:
accessing a data structure that stores a plurality of different types of item requests for items, wherein the different types of item requests each have a different corresponding time at which the items are allocated to that request type; and
allocating, by one or more servers, a same given item to various different requestors at different times based on the plurality of different types of item requests that have been submitted for the given item, including:
for a first portion of the allocations of the same given item, determining, by the one or more servers and prior to an allocation time for that allocation of the same given item, that the plurality of different types of item requests includes a reservation request that allocates the same given item to a requestor corresponding to the reservation request prior to the allocation time for that allocation of the same given item;
for a second portion of the allocations of the same given item, determining, by the one or more servers and prior to an allocation n time for that allocation of the same given item, that the same given item will not be allocated to a reservation request, but that an acceptable advance allocation request is included in the plurality of different types of item requests, allocating, by the one or more servers, the same given item to a requestor corresponding to the advance allocation request prior to an allocation time for that allocation of the same given item, and transmitting, by the one or more servers, a notification to other advance allocation requestors that the same given item has already been allocated; and
for a third portion of the allocations of the same given item, determining, by the one or more servers and prior to an allocation time for that allocation of the same given item, that the same given item will not be allocated to a reservation request or an advance allocation request, and allocating, by the one or more servers, the same given item at an allocation time corresponding to that allocation of the same given item, wherein the one or more servers evaluate the reservation requests upon receipt of the reservation requests, evaluate the advance allocation requests together at a first specified time prior to an allocation of the same given item, and evaluate other requests during an auction.

14. The non-transitory computer storage medium of claim 13, wherein the requests include data corresponding to monetary amounts, the method further determining a high bidder for the item request based on the monetary amounts.

15. The non-transitory computer storage medium of claim 13, the operations further comprising recording the determination of the requestor in the data structure.

16. The non-transitory computer storage medium of claim 13, the operations further comprising presenting, in response to a user request, information corresponding to which of the requestors was allotted the given item.

17. The non-transitory computer storage medium of claim 13, the operations further comprising updating a campaign associated with the given item after the determination.

18. The non-transitory computer storage medium of claim 13, the operations further comprising updating multiple campaigns after the determination, including updating at least one campaign associated with the losing requestor to indicate available budget to be spent on other additional requests based on losing the auction.
